(19) United States
(12) Patent Application Publication
(10) Pub. No.: US 2005/0035507 A1
(43) Pub. Date: Feb. 17, 2005

(54) Hydroeleastic joint with an overpressure channel having a variable cross-section

(75) Inventors: Etienne de Fontenay, Decize (FR); Philippe Souyri, Saint Genes Du Retz (FR)

Correspondence Address: FITZPATRICK CELLA HARPER & SCINTO, 30 ROCKEFELLER PLAZA, NEW YORK, NY, 10112, US

(73) Assignee: WOCO AVS SAS

(21) Appl. No.: 10/916,051

(22) Filed: Aug. 11, 2004

Related U.S. Application Data
(63) Continuation of application No. PCT/FR03/00387, filed on Feb. 2, 2003.

(30) Foreign Application Priority Data
Feb. 12, 2002 (FR) 02/01679

(51) Int. Cl. F16F 9/04

(52) U.S. Cl. 267/140.12

(57) ABSTRACT

Hydroelastic joint comprising an outer shell (1) and an inner shell (2) arranged one around the other and an elastically deformable element (6) arranged between the shells and shaped so that it defines at least two chambers (17a, 17b) opposite one another along a predefined damping direction (b), the chambers being able to communicate via at least one overpressure channel (25a, 25b) having at least one portion with variable cross-section, characterized in that it comprises force return means (24) to produce, from a force (F) tending to displace the shells relative to one another, a tightening force (P) at the level of the portion with variable cross-section of the overpressure channel, to oppose the circulation of damping liquid through the overpressure channel.

### CROSS REFERENCE TO RELATED APPLICATIONS

This is a continuation of International Patent Application Number PCT/FR03/00387, filed on Feb. 2, 2003, which claims priority to French Patent Application Number 02/01679, filed on Feb. 12, 2002.

### BACKGROUND OF THE INVENTION

1. Field of the Invention

The present invention concerns a hydroelastic joint designed to unite two components while damping vibrations transmitted from the one to the other.

1. The Related Art

Document DE 42 33 705 describes such a joint, of the type comprising an outer shell and an inner shell arranged one around the other and an elastically deformable element positioned between the said shells so as to allow a relative displacement between the shells, the said elastically deformable element being shaped so as to define, between the said shells, a volume containing a damping liquid and comprising at least two chambers opposite one another along a predefined damping direction, the said chambers being able to communicate via at least one resonance channel and at least one overpressure channel having at least one part with a variable cross-section.

Joints of this type have two main functions: to provide degrees of freedom between the components they unite, and to attenuate the transmission of vibrations between the said two components.

In the field of automobile vehicle construction such joints were first used to damp the drive aggregate relative to the main structure or body of a vehicle, and then also to damp the ground contact elements such as the suspension wishbones of wheel trains relative to the main structure.

In the second case the damping envisaged pertains in particular to displacement modes in the longitudinal direction of the vehicle, such as the recoil movement of a wheel on contact with an obstacle. Vibration sources known at the level of the ground contact elements of a vehicle are also, for example, the non-uniformity of tyres when running, disc brake defects and braking assistance devices. Vibrations of the ground contact elements are generally characterised by relatively low resonance frequencies, for example between 15 and 20 Hz, and relatively large amplitudes, for example of the order of a millimetre or more, so that they are perceptible by the vehicle's occupants if insufficiently damped.

Schematically, when a vibratory excitation is applied to one of the shells, at least in the damping direction, this results in an elastic deformation of the deformable element, which is made for example from an elastomer, with variation of the volume of the chambers, a pressure difference between them, and finally, a flow of damping liquid through the resonance channel. However, owing to the inertia of the liquid and to an extent amplified by the restricted cross-section of the resonance channel which gives rise to an increase in the speed of the liquid, this flow is out of phase with the force that provokes it and the phase shift results in a damping of the excitation transmitted to the second shell. The damping characteristics of this type of joint are determined in terms of a dynamic rigidity which is the ratio between the excitation transmitted to the second shell and the vibratory displacement applied to the first. Such a dynamic rigidity can be quantified in terms of the frequency and amplitude of the excitation displacement. Using classical complex number notation for the input displacement harmonic magnitudes and the output excitation, this dynamic rigidity is expressed in the form of a complex number characterised by an amplitude called the rigidity and a phase called the phase shift.

The behavior of this type of joint as a function of excitation frequency is typically as follows: the rigidity increases with frequency. The phase shift at first increases with frequency up to a maximum value reached at the pressure resonance frequency of the joint, beyond which the phase shift decreases or becomes stable. This behaviour is illustrated in FIGS. 9a and 9b using broken lines.

In a known way, the dynamic's rigidity can be adapted by choosing the composition and geometry of the deformable element, the viscosity of the damping liquid, which is for example a water/glycol mixture, and the cross-section and length of the resonance channel, in order to regulate the resonance frequency of the joint.

This resonance frequency corresponds to the frequency at which the damping performances of the joint are best, the phase shift being a maximum. The increase of the joint's rigidity with frequency is a disadvantage, in that within the frequency range in which the rigidity is high, typically above the pressure resonance frequency, the joint transmits vibrations very well. Thus, during a shock-type force on the joint, for example produced when the vehicle's wheel encounters an obstacle such as a road seam or a drain cover, that force comprises medium frequencies, for example of the order of 40 to 50 Hz, which are not damped by the resonance channel.

The overpressure channel is traditionally designed to protect the component against bursting during very violent excitations. It is therefore provided with an overpressure valve so as to remain closed during normal operation of the joint and only to open when there is a very large pressure difference between the two chambers, which constitutes a part having variable cross-section.

The document mentioned above proposes to prevent the dynamic stiffening of the joint in the event of shock, by an appropriate choice of the opening pressure of the overpressure valve, and circulation of liquid through the overpressure channel. However, there are two contradictory requirements since the valve must be sufficiently leak-proof not to suppress the effect of the resonance channel, in particular at low frequencies, but the opening pressure must be low enough to allow rapid opening in the event of shock.

Document DE 195 03 445 proposes a joint of the above-mentioned type in which the flap of the overpressure valve does not touch the opposite wall of the overpressure channel when at rest, so that the channel remains partially open. But then the resonance channel is then permanently short-circuited by the overpressure channel, so that the phase shift of the joint is not as effective.

Document EP 1 046 833 mentions that an improvement of the acoustic behaviour of the joint when a shock occurs can be obtained by reducing the friction between the flap of the overpressure valve and the opposite wall of the channel, by providing the valve flap with a soft area made of a finer or more flexible material than the remainder of the valve flap. However, this design makes the flap valve more fragile and increases its production cost.

FIGS. 9a, 9b, 10a and 10b show the results of dynamic rigidity measurements for two joints of the prior art with resonance frequencies of the order of 20 Hz and two different values of the overpressure valve closure tightness. The curves drawn with broken lines correspond to a classical tightness value for valves with a purely safety function, for example with radial compression over 1 to 1.5 mm of the material of the valve flaps. The curves drawn with continuous lines correspond to lower tightness, the valve flaps simply being in contact with the opposite wall of the channel without appreciable compression when the joints is at rest.

FIGS. 9a and 9b show respectively the dynamic rigidity |K| and the phase shift φ of the two joints subjected to a harmonic excitation along the damping direction without static preload, as a function of the frequency of that excitation. It can be seen that for frequencies higher than the resonance frequency, lower valve tightness reduces the rigidity by about 50%, this being the effect desired, and reduces the phase shift by about 30% at the resonance frequency, which is a disadvantage, but also that the phase shift improves at frequencies above 40 Hz, which is an advantage. All in all, the advantages can be considered to outweigh the phase shift reduction at resonance, because this remains at an acceptable level.

FIGS. 10a and 10b show the same parameters as FIGS. 9a and 9b respectively, obtained when the two joints are subjected to an additional static preload in the damping direction. While the advantageous effect of lower valve tightness on the dynamic rigidity is retained, in contrast the phase shift at resonance frequency is reduced by over 50% and there is substantial phase shift reduction at higher frequencies. This phase shift reduction is unacceptable since it removes any point in using a joint of the hydroelastic type rather than a simple metal-rubber joint.

Thus, with the known joints, even if an acceptable compromise can be found in terms of the opening pressure of the overpressure valves to improve the damping of shocks when the joint is deformed around its rest configuration, this is not the case when the joint is subjected to an additional static preload, such as the preload orientated along the longitudinal direction of the vehicle produced by the transfer of inertial mass to the joint of a ground contact element during the braking of the vehicle. The phase shift remaining is then insufficient, particularly around the resonance frequency.

### SUMMARY OF THE INVENTION

The purpose of the present invention is to overcome the above disadvantages at least in part, by proposing a joint which, when deformed around its rest configuration, ensures resonant damping of low-frequency excitations and damping of shock-type excitations, and which retains satisfactory resonant damping characteristics under an additional preload.

To that end, the invention provides a hydroelastic joint designed to unite two components while damping vibrations transmitted from one to the other, the said joint comprising an outer shell and an inner shell arranged one around the other and an elastically deformable element positioned between the said shells so as to allow relative movement between them, the said elastically deformable element being shaped so as to define, between the said shells, a volume containing a damping liquid and comprising at least two chambers opposite one another along a predefined damping direction, the said chambers being able to communicate via at least one overpressure channel having at least one part with variable cross-section, characterised in that it comprises force-return means for producing, from a force that tends to displace the said shells relative to one another along the said damping direction, a tightening effect at the level of the said or one of the said part(s) of the said overpressure channel having variable cross-section, to oppose the circulation of damping liquid through the said overpressure channel.

This characteristic makes it possible to design a joint which, around its rest position, allows damping liquid to circulate through the overpressure channel even when there are relatively small pressure differences between the two chambers, so as to damp shock-type excitations satisfactorily, and which, when subjected to a preload along the damping direction, restricts the circulation of damping liquid through the said overpressure channel and so improves the resonant damping produced by the joint.

In the joint according to the invention it is not necessary to connect the two chambers by a resonance channel different from the overpressure channel, since the overpressure channel or channels can fulfil a similar function, namely to allow liquid to flow between the two chambers out of phase with the excitation force, so damping the excitation transmitted to the second shell, by appropriate adjustment of their cross-section or opening pressure.

In a particular embodiment of the invention at least one resonance channel is provided which connects the said chambers, and which is connected in parallel with the said at least one overpressure channel.

Preferably, the part of the overpressure channel having variable cross-section comprises a flexible overpressure valve flap extending between two opposite sidewalls of the overpressure channel so that the latter is only opened when the pressure difference between the said chambers exceeds an opening threshold value, the said tightening force produced by the force-return means being able to compress the said valve flap between the two opposite sidewalls of the overpressure channel, to increase the said opening threshold value.

This characteristic enables the design of a joint provided with a valve flap which, at rest, is less tightly closed between the two opposite walls of the overpressure channel than in the traditional joints. However, when a preload is applied along the damping direction, the tightness of this valve flap is increased in order to restrict the circulation of damping fluid through the overpressure channel.

According to another characteristic of the invention, the part of the overpressure channel having variable cross-section comprises an inlet portion of the said overpressure channel which has a sidewall that can be displaced by the said force return means so as to constrict the said inlet portion. The circulation of damping fluid through the overpressure channel is then restricted by constricting this inlet portion of the overpressure channel.

According to a first embodiment of the invention, the force return means comprises a surface formed on the said inner shell and inclined so as to push some of the material of the said elastically deformable element transversely relative to a circulation direction defined by the said overpressure channel during a relative movement of the said shells along the damping direction.

Advantageously, the said inclined surface comprises part of the outer surface of the said inner shell.

Preferably, a reinforcement embedded in the said elastically deformable element is provided, the said embedded reinforcement having an opening opposite the said inclined surface of the force return means to allow a displacement of the material of the said elastically deformable element pushed by the said inclined surface through the said embedded reinforcement.

In a second embodiment of the invention, the force return means comprises a semi-rigid body in contact with at least one of the said chambers, this body having a flexure zone capable of being held between the said outer and inner shells so as to cause the said flexure zone to bend elastically when the inner and outer shells are displaced in the said damping direction, and at least one closure zone that can pivot so as to reduce the cross-section of the said variable-section part of the overpressure channel in response to the bending of the said flexure zone.

According to a first advantageous characteristic of the second embodiment, the semi-rigid body has an elastic sheet undulated essentially in a W shape, a central arch of which projects between the said outer and inner shells essentially parallel to the damping direction to form the said flexure zone, and at least one lateral wing of which forms the said closure zone.

According to a second advantageous characteristic of the second embodiment, the inner and outer shells are essentially cylindrical and have a common axial direction, and the said semi-rigid body comprises a cylindrical elastic envelope whose axis is essentially parallel to the said common axial direction and whose flexure zone is defined between two essentially axial ridges along which the said envelope rests against an inner surface of the outer shell.

Preferably, the flexure zone is held between the said outer shell and an abutment body on the said inner shell, which projects in the said damping direction.

Preferably, the closure zone of the semi-rigid body forms a lateral partition of the said variable-section part of the overpressure channel. Advantageously in this case, this lateral partition carries a valve flap extending towards an opposite sidewall of the said overpressure channel, or a sidewall of the overpressure channel opposite the said lateral partition of the semi-rigid body carries a valve flap and the lateral partition can rest on a free end of the said valve flap so as to press against the latter.

According to another characteristic of the invention, a resonance channel is provided which extends between the said chambers, bypassing the other side of the said lateral partition relative to the overpressure channel, and the lateral partition has an aperture which opens into the said resonance channel.

Preferably, the semi-rigid body can cause a cross-section of the resonance channel defined between the said lateral position and the said outer shell to vary in the sense inverse to the variable cross-section of the overpressure channel, so as to increase a resonance frequency of the resonance channel when the inner and outer shells are displaced along the damping direction.

When the joint is used in a vehicle's ground contact system and is subjected to preloading in the damping direction during braking, this characteristic makes it possible to obtain an evolution of the resonance frequency of the resonance channel that matches the evolution of the frequencies of the vehicle's suspension system itself, which increase during braking. Thus, the damping produced by the joint is improved by the fact that the resonance frequency of the joint and the frequencies of the suspension itself can remain in tune over a wider operating range, both in the absence of braking and during braking.

Advantageously, the said elastically deformable element has two end partitions which connect the said inner and outer shells in a leak-proof way at the level of opposite sides of the latter to contain the said volume of damping fluid, the said semi-rigid body being designed to ensure that no substantial leakage occurs between the said end partitions and the edges of the semi-rigid body. Thus, any leakage flow that short-circuits the overpressure channel is very small.

In a third embodiment of the invention, an additional shell is provided arranged around the said outer shell, the said force return means then comprising a hydraulic circuit defined between the outer shell and the said additional shell, this hydraulic circuit comprising a first reservoir separated from one of the said damping liquid chambers by a first flexible membrane mounted in a first opening of the said outer shell opposite an abutment body formed on the said inner shell that projects in the said damping direction, and a second flexible membrane mounted in a second opening of the said outer shell, this second flexible membrane forming an outer sidewall of the said part of the overpressure channel with variable cross-section, the said second reservoir being connected to the said first reservoir so that an outward deformation of the first membrane under the pressure of the said abutment body results, by hydraulic pressure transmission, in an inward deformation of the said second membrane, which constricts the cross-section of the overpressure channel.

Preferably, the second elastically deformable element is arranged between the said additional shell and the said outer shell, and the hydraulic circuit is formed in this second elastically deformable element.

### BRIEF DESCRIPTION OF THE DRAWINGS

The invention will be better understood and other purposes, details, characteristics and advantages of it will emerge more clearly from the description given below, of several particular embodiments of the invention, which are presented only for illustrative and not limiting purposes, with reference to the attached drawings in which:

FIG. 1 shows a joint according to the first embodiment of the invention, in longitudinal section along the line I-I in FIG. 2

FIG. 2 shows the joint of FIG. 1 in cross-section along the line II-II

FIG. 3 is a view analogous to that of FIG. 2 showing a first variant of the second embodiment of the invention

FIG. 4 shows a perspective view of a semi-rigid body of the joint in FIG. 3

FIG. 5 is a view analogous to FIG. 2 showing a joint according to a second variant of the second embodiment of the invention

FIG. 6 shows a perspective view of a semi-rigid body of the joint in FIG. 3

FIG. 7 is a view analogous to FIG. 2 showing a joint according to a third variant of the second embodiment of the invention

FIG. 8 is a view analogous to FIG. 2 showing a joint according to a third embodiment of the invention

FIGS. 9a and 9b show, for two joints of the prior art, the dynamic rigidity and the phase shift observed during a harmonic excitation without static preload

FIGS. 10a and 10b show, for the two joints of the prior art, the dynamic rigidity and the phase shift observed during a harmonic excitation with a static preload

FIG. 11 shows a partial cross-section of a variant embodiment of the joint illustrated in FIG. 3

FIG. 12 shows a partial cross-section of a variant embodiment of the joint illustrated in FIG. 5

FIGS. 13 and 14 show partial cross-sections of variant embodiments of the joint illustrated in FIG. 7

### DETAILED DESCRIPTION OF THE INVENTION

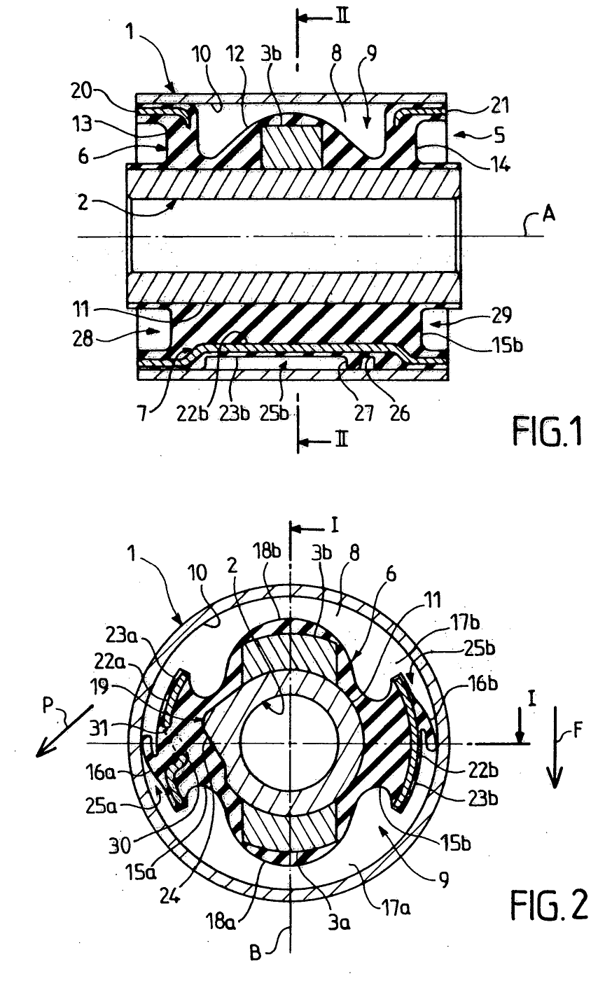

A first embodiment of the invention will now be described with reference to FIGS. 1 and 2. In this embodiment the external shape of the joint is essentially cylindrical with a circular cross-section and it has an outer shell 1 and an inner shell 2, which are essentially cylindrical and coaxial, with axis A. These shells are rigid and made for example of metal or plastic. The outer 1 and inner 2 shells are designed to be fixed respectively to two components of a structure (not shown), to unite those components and damp the transmission of vibrations between them. To facilitate the mounting of the joint between the two components, the inner shell 2 extends longitudinally beyond the outer shell 1 at both ends of the joint.

Between the inner 2 and outer 1 shells is mounted an assembly 5 constituting a hydraulic damping spring formed by an elastically deformable element 6 made of a composition of one or more elastomer(s) provided with an enclosed reinforcement 7, and by a hydraulic damping liquid 8 which fills a leak-proof space 9 delimited between the deformable element 6 and the inside surface 10 of the outer shell 1. The overall shape of the deformable element 6 is that of a hollow cylindrical sleeve bonded at its inside surface to the outer surface 11 of the inner shell 2 and recessed on its outer surface 12 to form the space 9.

The external shape of the deformable element 6 is as follows: the deformable element 6 is recessed in a central portion between its two axial ends, so as to form at the level of its axial ends two annular walls 13 and 14 which extend between the inner 2 and outer 1 shells to close the space 9 in a leak-proof way. Two diametrically opposed axial protrusions 15a and 15b extend respectively to the walls 13 and 14 so that the space 9 is divided into two essentially semi-annular chambers 17a and 17b which are symmetrical relative to a plane containing the axis A of the joint and the median lines of the protrusions 15a and 15b. The two chambers 17a and 17b are diametrically opposite along a direction B which defines the hydraulic damping direction of the assembly 5.

The bottom of each chamber 17a and 17b is formed with a respective bulge 18a and 18b projecting radially outwards from the centre of the chamber, which constitutes an abutment body that can come into contact against the inside surface 10 of the outer shell 1 when the shells 1 and 2 are displaced relative to one another in the direction B. Beyond a certain displacement threshold, one of the bulges 18a and 18b, depending on the displacement direction, contacts the inside surface 10 so that the rigidity of the joint is increased in the direction B. Thus, the bulges 18a and 18b prevent excessive deformation of the deformable element 6 in the direction B in order to avoid damage to the walls 13 and 14 when the joint is subjected to a very pronounced radial excitation.

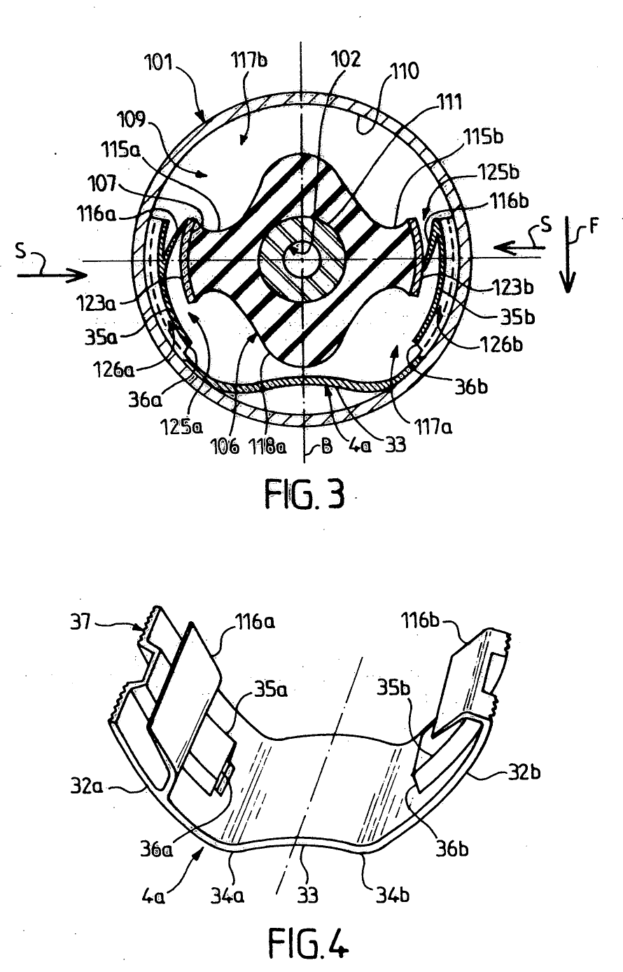

In the embodiment shown in FIGS. 1 and 2 each of the bulges 18a and 18b of the deformable element 6 encloses at its centre a rigid ring 3a, 3b respectively, which is in contact with the outer surface 11 of the inner shell 2 and is embedded in the mass of the deformable material. The rings 3a, 3b for example made of metal, serve to stiffen the bulges 18a and 18b in the direction B so as to increase the rigidity of the joint when one of the bulges 18a and 18b comes into contact with the inner surface 10. As a variant, the bulges 18a and 18b can also be wholly mad from the material of the deformable element 6, without any rigid ring, as in the embodiment shown in FIG. 3, so as to make the stiffening of the joint more progressive.

The reinforcement 7 is embedded in the elastic mass of the deformable element 6. The reinforcement 7 consists of a section of tube essentially the same length as the outer shell 1 and coaxial with it, provided in its central portion with two openings each covering a wide angular sector, for example of about 120°, around the axis A. Each of these openings corresponds to the position of one of the chambers 17a and 17b, and allows the passage of the bulge 18a or 18b for the latter to come up against the outer shell 1. Thus, at the level of its axial ends the reinforcement 7 forms two rings 20 and 21 embedded in the periphery of the walls 13 and 14 respectively, and adjoining the rings 20 and 21, two strips 22a and 22b parallel to the axis A, which are radially slightly constricted relative to the rings 20 and 21 and are embedded in the protrusions 15a and 15b respectively. Thus, at the outer surface of its end walls 13 and 14 the deformable element 6 has two annular recesses 28 and 29 formed in the mass of the elastomer, between the inner shell 2 and the embedded reinforcement 7.

The strips 21a and 22b of the embedded reinforcement 7 are covered on their outer surface by a thin layer of the material of the deformable element 6, which forms the crown surfaces 23a and 23b of the protrusions 15a and 15b respectively. Thus each of the surfaces 23a and 23b has the shape of a cylindrical sector which conforms to the inside surface 10 of the outer shell 1 with some radial clearance. This radial clearance, essentially equal to the amount of the radial constriction of the strips 22a and 22b, defines the communication channels between the two chambers 17a and 17b.

More precisely, between the crown surface 23b and the inner surface 10 there are defined an overpressure channel 25b and a resonance channel 26, which extend parallel to the peripheral direction of the outer shell 1 and are separated by a ridge 27 formed integrally in the mass of the deformable element 6. The resonance channel 26 is a channel of small section which connects the two chambers 17a and 17b to produce a pressure resonance at a given resonance frequency, in accordance with known methods. Between the crown surface 23a and the inner surface 10 there are defined an overpressure channel 25a and another resonance channel (not shown) identical to the resonance channel 26. As a variant, the overpressure channel 25a can occupy the full axial length of the surface 23a without any second resonance channel.

Each crown surface 23a and 23b has, along an axial line corresponding essentially to the median plane of the protrusions 15a and 15b, a respective flexible valve flap 16a and 16b that can be seen in FIG. 2. The valve flaps 16a and 16b extend over the full width of the overpressure channels 25a and 25b and are formed as an integral part of the material of the deformable element 6. The valve flap 16b is omitted from FIG. 1. At rest, an end portion of the flaps 16a and 16b is in contact against the inside surface 10 of the outer shell 1 so as to seal the overpressure channels 25a and 25b hermetically. The two flaps 16a and 16b have a helicoidal orientation in the same rotation direction about the axis A. If the joint is excited in a radial direction, resulting in a sufficient overpressure in one of the chambers, for example chamber 17a, one of these flaps, 16a in the example, is pushed in its wrapping direction so that it bends towards the protrusion carrying it, 15a in the example, and communication is opened between the two chambers through the overpressure channel 25a so that the liquid pressure can equalise. The other flap, 16b in the example, is by contrast pushed by the liquid overpressure in its unwrapping direction, so that it remains against the outer shell 1 and does not open a communication between the two chambers through the channel 25b. If the excitation takes place in the converse direction, the operation of the two flaps 16a and 16b is inverted.

Under the protrusion 15a, the inner shell 2 has on its outside surface 11 a protrusion 19 parallel to the axis A, one slope of which forms a flat surface inclined, for example at an angle of 20° to 60°, preferably about 45°, relative to the radial extension direction of the protrusion 15a. The axial strip 22a of the embedded reinforcement 7 also has an axially extending portion 30 underneath the valve flap 16a, radially offset inwards towards the inner shell 2, so as to form an inclined face parallel to the surface 24 which has then been partially removed by making a cut-out 31.

The volume 9 is closed by force-fitting the outer shell 1 over the deformable element 6 after filling with the damping liquid. Filling can be carried out by immersing the joint in the liquid. The two rings 20 and 21 confer upon the deformable element 6 high radial rigidity at the level of the walls 13 and 14 to ensure leak-proof contact with the outer shell 1. The deformable element 6 is not bonded to the outer shell 1 but held in it by the friction produced by a thin film of its material radially compressed between the surface 10 and the rings 20 and 21.

The opening pressure of the valve flaps 16a and 16b can be adapted by designing them appropriately, adjusting their axial and radial extension, their thickness and the nature of the elastic material used. In the absence of any static force that displaces the shells 1 and 2 relative to one another along the damping direction B, the valve flaps 16a and 16b are designed to have a level of compression pre-stress against the shell 1 which is fairly low, to allow the overpressure channels to open when the joint is subjected to a shock-type excitation, for example affecting a main component at a frequency between 40 and 50 Hz and an amplitude of the order of a few tenths of a millimetre. This pre-stress level is generally lower than that used when the overpressure valves only have a safety function, which avoids bursting of the joint under very severe excitation. The compression pre-stress of the valve flaps 16a and 16b against the shell 1 can also be made virtually zero, preferably however without leaving a passage between the two chambers through the overpressure channels in the rest position.

In operation, the valve flap 16a has several tightness levels depending on the type of excitation to which the joint is subjected. In effect, when the joint is subjected to a static or quasi-static differential excitation, represented by the arrow F in FIG. 2, which displaces the inner shell 2 towards the chamber 17a, the inclined surface 24 pushes the material of the deformable element 6 underneath the valve flap 16a through the cut-out 31 so as to displace the base of the valve flap 16a both outwards in the radial direction and towards the inlet of the overpressure channel 25a in the peripheral direction. This pushing force, represented by the arrow P in FIG. 2, increases the tightness of the valve flap 16a against the outer shell 1 and so increases its opening pressure.

Note that the result is similar if the force F displaces the inner shell 2 towards the protrusion 15a. In contrast, if the cut-out 31 were absent a displacement of the inner shell 2 could not modify the tightness of the valve flap 16a, because the latter is carried by the embedded reinforcement 7 which occupies an essentially fixed position relative to the outer shell 1 because of the rigidity of the shells and the connection between them at the level of the rings 20 and 21.

In the presence of the static force F, when the joint is subjected to a vibratory excitation around this displaced configuration, the circulation of the damping liquid 8 from the chamber 17a to the chamber 17b through the overpressure channel 25a is restricted by the increased opening pressure of the valve flap 16a and is blocked through the overpressure channel 25b. Consequently, the circulation of damping liquid through the resonance channels is increased, which improves the damping produced by the joint, especially at frequencies close to the resonance frequency of the resonance channels. In other words, the leak flow through the overpressure channel 25a which had been favoured by relaxing the valve flap 16a is opposed during the application of a static preload along the damping direction, by the retightening of the valve flap against the outer shell 1. Because of this, the phase shift of the joint under static preload is increased back up to a satisfactory level, for example of the order of 30° to 50° at the resonance frequency.

Of course, an analogous function of the overpressure valve 16b can be obtained by making the joint symmetrical relative to the axis A.

With reference to FIGS. 3 to 7, a second embodiment of the invention will now be described. Elements identical or similar to those of the first embodiment are indexed with the same number increased by 100 and will not be described again. In this second embodiment the inner shell 102 has a circular cylindrical outer surface 111 and the embedded reinforcement 107 has no cutout at the level of the protrusion 115a. A semi-rigid body made for example from metal or a plastic material, in particular polyamides, is in contact with the space 109.

A first variant of the second embodiment will now be described with reference to FIGS. 3 and 4. The protrusions 115a and 115b have neither a valve flap nor a ridge. The body 4a comprises a base sheet which is essentially rectangular and has longitudinal undulations that give it a cross-section essentially in the shape of a W, with two side wings 32a and 32b curving inwards with a curvature like that of the inside surface 110 of the outer shell 101, and an intermediate arch 33 curving slightly inwards in the opposite direction and joined to the wings 32a and 32b at the level of two bends 34a and 34b respectively. Each side wing 32a and 32b has, at the level of a median portion, a portion 35a and 35b which is detached towards the centre of curvature of the side wing and extends from the end edge of the wing essentially as far as the bend 34a or 34b, ending in a respective opening 36a and 36b at its end near the said bend. For each side wing 32a and 32b of the base sheet a valve flap, 116a and 116b respectively, is fixed on the face on the inside of the curve of the wing, preferably formed integrally with the base sheet. The valve flaps 116a and 116b extend along the full length of the base sheet, passing above the detached portions 35a and 35b.

Each flap 116a and 116b has, on either side of the detached portion of the wing 32a or 32b carrying it, a base part essentially perpendicular to the wing and, above the detached portion, an end part connected via a bend to the base part and orientated obliquely along the wing inclined slightly away from the latter. The end part has decreasing thickness. The flap 116a has its end part orientated towards the end of the wing 32a and the flap 116b has its end orientated towards the intermediate arch.

The body 4a is inserted into the space 109 by wrapping it transversely around the deformable element 106, with the intermediate arch 33 extending into the chamber 117a transversely to the damping direction B and the two wings 32a and 32b engaging between the crown surfaces 123a and 123b of the protrusions 115a and 115b and the outer shell 101. The outer surface of the wings 32a and 32b rests against the inner surface 110 as far as the bends 34a and 34b. It is provided with grooving 37 to reduce the friction against the inner surface 110. The intermediate arch 33 is detached from the inner surface 110 and projects slightly at the centre of the chamber 117a towards the bulge 118a of the deformable element 106. In the radial space between the crown surface 123a and 123b and the outer shell 101, each wing 32a or 32b forms a partition separating an overpressure channel 125a or 125b, defined between the said partition and the crown surface 123a or 123b, from a resonance channel 126a or 126b which is defined between the inner surface 110 and the detached portion 35a or 35b. The end of the valve flaps 116a and 116b comes into contact with the respective crown surface 123a or 123b, blocking the overpressure channels 125a and 125b hermetically. The tightness of the valve flaps 116a and 116b at rest is adjusted according to the same criteria as in the first embodiment.

The length of the body 4a is essentially the same as the axial length of the space 109 so that a certain level of hermetic sealing is ensured between the longitudinal end edges of the base sheet and the axial end walls of the space 109, so that the leakage flow short-circuiting the channels by passing under the arch 33 is small enough not to affect the damping properties of the joint adversely. However, the body 4a is also designed and arranged such that it does not damage the axial end walls of the space 109, which generally constitute a zone of fragility in hydroelastic joints.

When a force F displaces the shells 101 and 102 relative to one another so that the volume of the chamber 117a is reduced, the bulge 118a comes in contact with the middle of the arch 33 and causes it to bend elastically towards the surface 110. The body 4a is deformed by bending so that the side wings 32a and 32b approach one another by pivoting around the bends 34a and 34b, which constitute pivoting axes that can if necessary slide slightly along the surface 100. The pivoting of the side wings 32a and 32b results in a tightening force, indicated by the arrows S in FIG. 3, which increases the opening pressure of the valve flaps 116a and 116b.

At the same time, when the side wings 32a and 32b pivot inwards the cross-section of the resonance channels 126a and 126b increases except at the level of their inlets delimited by the openings 36a and 36b. This variation of the configuration results in an increase of the resonance frequency of the resonance channels.

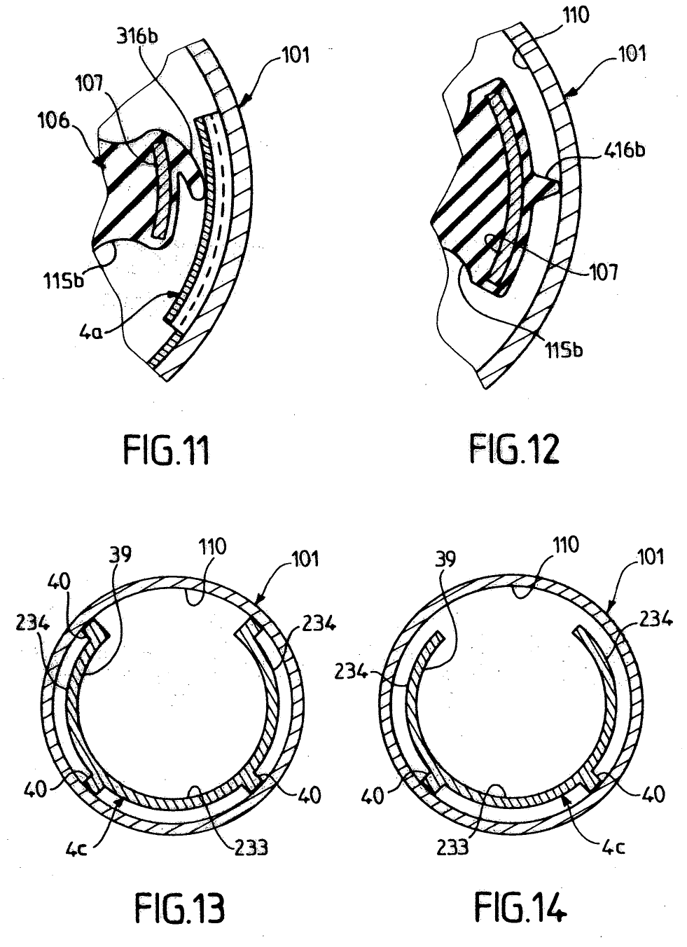

FIG. 11 shows a partial view of an alternative embodiment of the first variant mentioned above, in which the valve flaps 116a and 116b on the body 4a are omitted and replaced by valve flaps similar to the flaps 16a and 16b shown in FIG. 2 and carried by the protrusions of the deformable element 106. FIG. 11 shows such a valve flap 316b on the protrusion 115b and moulded over the embedded reinforcement 107. The other flap can be made in an analogous way.

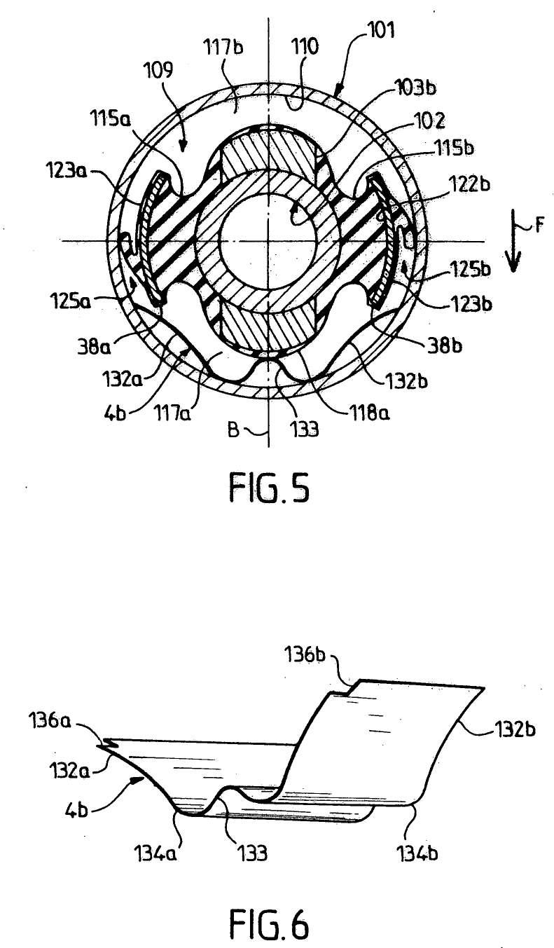

A second variant of the second embodiment will now be described with reference to FIGS. 5 and 6. In this variant the valve flaps are carried by the protrusions 115a and 115b and their tightness at rest is adjusted in accordance with the same criteria as in the first embodiment.

In the second variant, the body 4b comprises an essentially rectangular metallic sheet having longitudinal undulations that give it an essentially W-shaped cross-section, with two side wings 132a and 132b that curve inwards and an intermediate arch 133 that curves inwards in the same direction, which joins the wings 132a and 132b at the level of two bends 134a and 134b that curve inwards in the opposite direction to the intermediate arch 133.

The side wings 132a and 132b are not as wide as the wings 32a and 32b of the first variant and only engage in an inlet part of the overpressure channels 125a and 125b. This inlet part has a variable cross-section defined between the wing 132a or 132b and an edge 38a or 38b of each of the protrusions 115a and 115b, which comprises an edge of the strip 122a or 122b covered by a thin film of the material of the deformable element 106.

During a relative displacement of the shells 101 and 102 produced by the force F and resulting in a volume reduction of the chamber 117a, the bulge 118a comes in contact with the middle of the arch 133, causing it to bend elastically towards the surface 110. The body 4b deforms by sliding of the bends 134a and 134b along the surface 110 and by the resultant pivoting of the side wings 132a and 132b towards one another, so that the inlet cross-section of the overpressure channels decreases, up to complete closure when an end part of each of the side wings 132a and 132b comes into hermetic contact against the edge 38a or 38b.

Since the length of the body 4b is essentially the same as the axial length of the space 109, so ensuring a degree of hermetic sealing between the longitudinal end edges of the sheet and the axial end walls of the space 109, the side wings 132a and 132b in contact with the edges 38a and 38b hermetically block the inlet of the overpressure channels 125a and 125b on the side of the chamber 117a. However, a cut-out 136a or 136b made in the end part of each side wing 136a or 136b allows the resonance channels not to be blocked since the edge of the cut-out comes in contact against the separation ridge between the resonance channel and the overpressure channel.

As in the first embodiment, when a static force F displaces the inner shell 102 towards the chamber 117a and when the joint is subjected to vibratory excitation, the circulation of damping liquid through the overpressure channels 125a and 125b is prevented by the body 4a which blocks their inlet so that the circulation of damping liquid through the resonance channels is increased.

Of course, analogous operation of the joint can be obtained when the inner shell 102 is displaced towards the chamber 117a by providing a second body 4b in it.

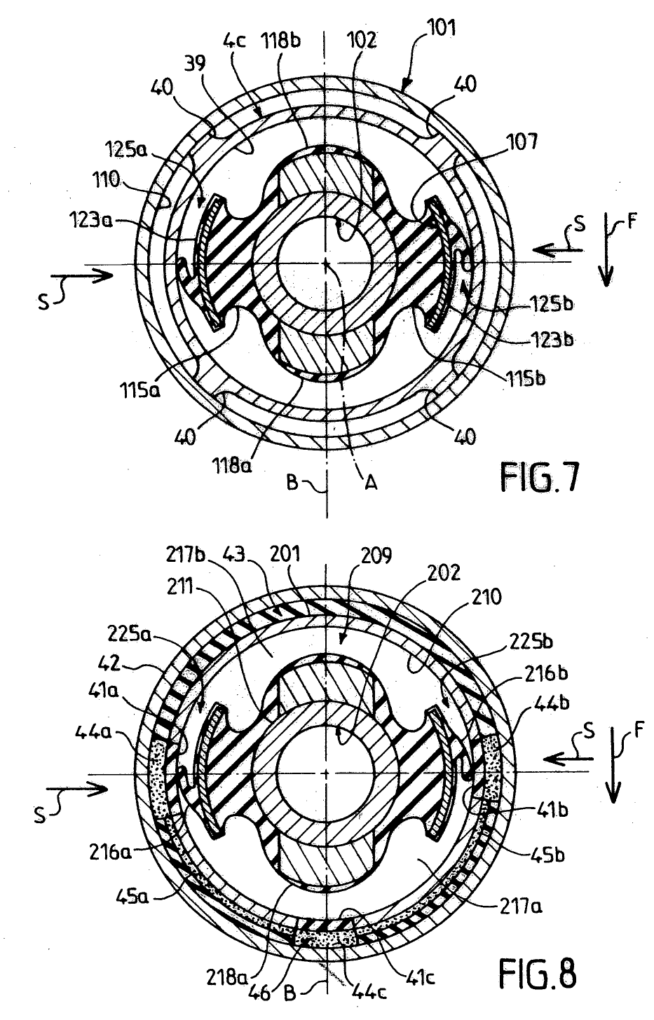

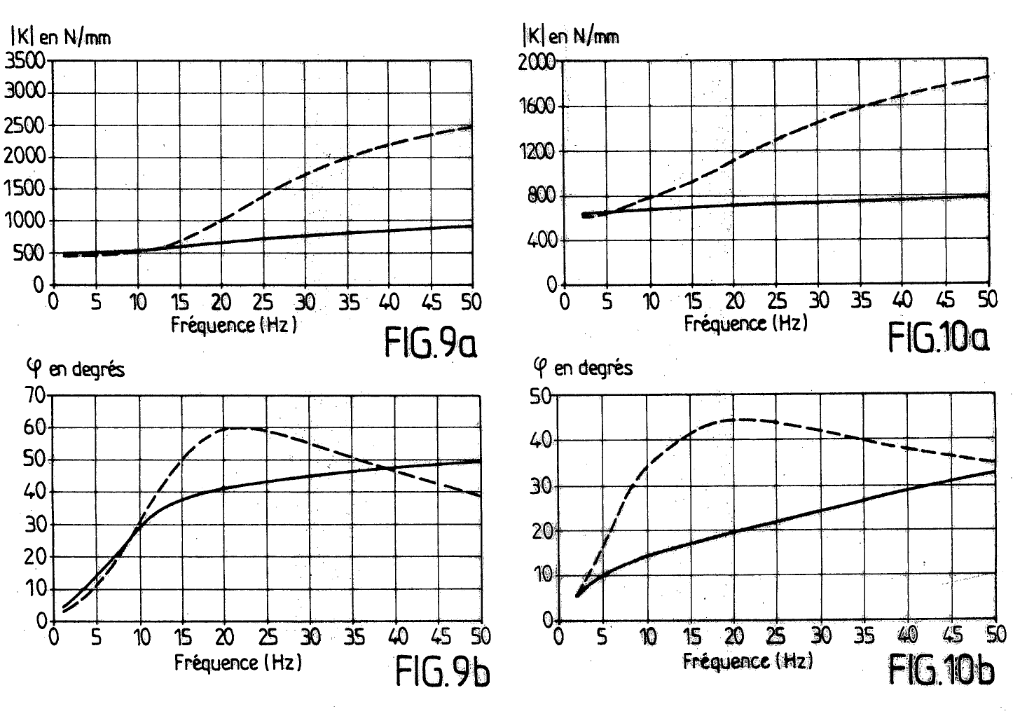

A third variant of the second embodiment will now be described with reference to FIG. 7. In this variant the semi-rigid body 4c comprises a circular cylindrical tube with an elastically deformable cross-section arranged around the deformable element 106 inside the outer shell 101. The overpressure channels 125a and 125b are delimited between the crown surfaces 123a and 123b, on which there are valve flaps, and the inside surface of the body 4c.

Over its entire axial length the body 4c rests against the inner surface 110 on axial ridges 40, for example 4 of them, which are distributed regularly at the periphery of the body 4c. In the example shown the positions of the axial ridges 40 are about 45° away, around the axis A, relative to the damping direction B.

At the level of the axial ends of the body 4c, two alternative configurations are envisaged. In the first of these the length of the body 4c is essentially the same as the axial length of the space 109 and it only extends within the space 109 between the axial end walls of the space 109 (indexes 13 and 14 in FIG. 1). There is therefore a certain level of tightness between the said walls and the longitudinal end edges of the body 4c so that the leakage flow that can short-circuit the resonance channels by passing between the body 4c and the outer shell 101 is restricted.

In the second configuration the length of the body 4c is essentially the same as the axial length of the embedded reinforcement 107. The rings at the end of the reinforcement 107 (indexed 20 and 21 in FIG. 1) are force-fitted into the body 4c instead of the outer shell 101. The outer shell 101 is thus held around the body 4c by the grip of the ridges 40.

The body 4c is designed to be able to deform, at least at the level of a central portion, so as to become oval under the pressure of the bulge 118a or 118b when it contacts the surface 39 between two ridges 40. Thus, when the joint is subjected to the static preload force F, the body 4c bends elastically so that, at least at the level of a central portion, it adopts an essentially elliptical cross-section with major axis parallel to the damping direction B and minor axis corresponding to the radial direction of the protrusions 115a and 115b. Because of this, the surface 39 exerts an increased tightening force, indicated by the arrows S, on the valve flaps. In the case of the second configuration mentioned above, the end parts of the body 4c are designed to continue ensuring leak-proof contact with the deformable element 6 even in the condition when the body 4c is deformed.

As in the first embodiment, in the presence of the static force F and when the joint is subjected to vibratory excitation, the circulation of damping liquid through the overpressure channels 125a and 125b is restricted by the increased tightness of the valve flaps 116a and 116b, so that the circulation of damping liquid through the resonance channels is favored.

The body 4c need not necessarily have a complete tubular shape, but can also take the form of a semi-tubular section with a cross-section in the form of a circular arc of greater or lesser length. FIGS. 13 and 15 show partial views of two corresponding embodiments of the body 4c for the above-mentioned third variant. In these figures the inner shell and the deformable elements are not shown, because they are identical to those of the embodiment in FIG. 7.

In FIG. 13 the body 4c has the form of a semi-tubular sector with a cross-section shaped as a circular arc covering about 270°, which can be obtained by omitting the wall of the tubular body 4c in FIG. 7 between two of the ridges 40. The median wall 233 of the body 4c in FIG. 13, in the circumferential direction, constitutes a favoured flexure zone which is positioned opposite the bulge 118a, as seen in FIG. 7, to produce bending of the body 4c which tends to bring the wings 234 towards one another under the action of the above-mentioned preload force F. The operation of this embodiment of the body 4c is similar to that of the body 4a described earlier. The embodiment of the body 4c shown in FIG. 14 is identical except that the two ridges 40 are omitted at the free ends of the wings 34. Thus, only two axial ridges 40 remain in contact against the surface 110, on either side of the median wall 233.

The angular extension of the body 4c and the number of ridges 40 are chosen larger or smaller so as to adjust the flexibility of the body 4c. Preferably, this extension is more than 180° so as always to ensure satisfactory contact with the valve flaps. However, the position of the said flaps can be modified and the extension of the body 4c adapted accordingly.

A third embodiment of the invention will now be described with reference to FIG. 8. Elements identical or similar to those of the first embodiment are indexed with the same number increased by 200, and will not be described again.

At the level of the contact zones of the ends of the valve flaps 216a and 216b, the outer shell 201 is perforated with openings, for example circular, in which flexible membranes 41a and 41b are fixed in a leak-proof way, for example by adhesive bonding. Another opening provided with a membrane 41c is provided opposite the bulge 218a in the radial direction B. An additional shell 42, of circular cylindrical shape and coaxial with the outer shell 201, is fixed around the latter by means of a second elastic element 43, for example an elastomer layer. Within the material of the second elastic element 43, between the shells 201 and 42, a leak-proof circuit 46 is hollowed out, which is filled with a fluid of low compressibility, for example the damping liquid or another liquid or gaseous fluid, and which comprises a fluid reservoir 44a, 44b and 44c behind each respective membrane 41a, 41b and 41c and two connector ducts 45a and 45b which connect the reservoir 44c to the reservoirs 44a and 44b respectively.

When the shells 201 and 202 are relatively displaced by a sufficient amount by the force F in a direction that reduces the volume of the chamber 217a, the bulge 218a comes in contact with the membrane 41c so that the volume of the reservoir 44c is reduced. Fluid flows through the ducts 45a and 45b to the reservoirs 44a and 44b so as to expand the membranes 41a and 41b towards the inside of the outer shell 201, and this produces a tightening force, indicated by the arrow S, applied to the valve flaps 216a and 216b.

As in the first embodiment, in the presence of a static force F and when the joint is subjected to vibratory excitation, the circulation of damping liquid through the overpressure channels 225a and 225b is restricted by the increased tightness of the valve flaps 216a and 216b so that the circulation of damping liquid through the resonance channels is favored.

In all the embodiments the presence of resonance channels permanently connecting the liquid chambers is not necessary, because satisfactory although different damping can be obtained by causing all the liquid flow to pass only through the overpressure channels, provided that the dimensions of the overpressure channels and if necessary the opening pressure of the valve flaps are chosen appropriately. For example, a slight clearance can be provided between each valve flap in the rest position and the opposite wall of the overpressure channel, or the said valve flaps can be made slightly undersize.

In all the embodiments the presence of valve flaps is not indispensable. In particular, if less damping at low frequencies is acceptable it is not necessary to have valve flaps, nor a resonance channel separate from the overpressure channels. With no preload, the overpressure channels then provide a permanent passage for the liquid between the two chambers. However, under a preload the various embodiments described allow a constriction of the parts of the overpressure channels that have variable cross-section, and therefore an increase of the pressure losses in the overpressure channels whose effect is to improve the damping of vibrations. An example embodiment of a hydroelastic joint without valve flaps or a resonance channel can be obtained by correspondingly modifying the embodiment shown in FIG. 5. In this case it is appropriate to omit the cutouts 136a and 136b. In the presence of a static load F that displaces the inner shell 102 towards the chamber 117a and when the joint is subjected to vibratory excitation, the circulation of the damping liquid through the overpressure channels 125a and 125b is interfered with by the body 4b blocking their inlet, so that the viscous damping is improved.

When valve flaps are provided, they can have a straight shape in the radial direction. FIG. 12 shows a partial view of such a valve flap 416b, used in an alternative of the embodiment shown in FIG. 5. The flap 416b is moulded over the embedded reinforcement 107 and extends radially towards the surface 110 of the outer shell 101.

Although the invention has been described in connection with several particular embodiments, it is quite clearly not in any way limited to these alone but covers all technical equivalents of the means described and their combinations if the latter fall within the scope of the invention.

1. A hydroelastic joint comprising an outer shell and an inner shell arranged one around the other and an elastically deformable element arranged between the shells so as to allow a relative displacement between the shells, the elastically deformable element being shaped so that it defines between the shells a space which comprises a damping liquid and at least two chambers opposite one another in a predefined damping direction, the chambers being able to communicate via at least one overpressure channel which has at least one part with a variable cross-section, wherein the hydroelastic joint further comprises force return means to produce, from a force which tends to displace the shells relative to one another along the damping direction, a tightening force at the level of the part of the overpressure channel with variable cross-section, in order to oppose the circulation of damping liquid through the overpressure channel.

2. The hydroelastic joint according to claim 1, wherein the variable cross-section part of the overpressure channel has a flexible flap of an overpressure valve that extends between two opposite sidewalls of the overpressure channel such that the overpressure channel is only opened when the pressure difference between the chambers exceeds an opening threshold value, the tightening force produced by the force return means being able to compress the valve flap between the opposite sidewalls of the overpressure channel to increase the opening threshold value.

3. The hydroelastic joint according to claim 1 or 2, wherein the variable-section part of the overpressure channel comprises an inlet portion of the overpressure channel having a sidewall that can be displaced by the force return means so as to block the inlet portion.

4. The hydroelastic joint according to claim 1, wherein the force return means comprises an inclined surface formed on the inner shell and wherein the inclined surface is inclined so as to push some of the material of the elastically deformable element transversely relative to a circulation direction defined by the overpressure channel during a relative displacement of the shells in the damping direction.

5. The hydroelastic joint according to claim 4, wherein the inclined surface comprises part of the outer surface of the inner shell.

6. The hydroelastic joint according to claim 4, further comprising an embedded reinforcement in the elastically deformable element, wherein the embedded reinforcement comprises an opening opposite the inclined surface of the force return means to allow a displacement of the material of the elastically deformable element pushed by the inclined surface through the embedded reinforcement.

7. The hydroelastic joint according to claim 5, further comprising an embedded reinforcement in the elastically deformable element, wherein the embedded reinforcement comprises an opening opposite the inclined surface of the force return means to allow a displacement of the material of the elastically deformable element pushed by the inclined surface through the embedded reinforcement.

8. The hydroelastic joint according to claim 1, wherein the force return means comprises a semi-rigid body in contact with at least one of the chambers, and wherein the semi-rigid body comprises
(a) a flexure zone able to be held between the outer and inner shells so as to cause the flexure zone to bend elastically when the inner and outer shells are displaced along the damping direction, and
(b) at least one tightening zone able to pivot so as to reduce the cross-section of the variable-section part of the overpressure channel in response to the bending of the flexure zone.

9. The hydroelastic joint according to claim 8, wherein the semi-rigid body further comprises an elastic undulating sheet essentially in the shape of a W, which comprises:
(a) a central arch which projects between the outer and inner shells essentially parallel to the damping direction to form the flexure zone, and
(b) at least one side wing which forms the tightening zone.

10. The hydroelastic joint according to claim 8, wherein the inner and outer shells are essentially cylindrical and have a common axial direction, and wherein the semi-rigid body comprises a cylindrical elastic envelope having an axis essentially parallel to the common axial direction and having a flexure zone defined between two essentially axial rides on which the envelope rests against an inside surface of the outer shell.

11. The hydroelastic joint according to claim 8, 9 or 10, wherein the flexure zone is held between the outer shell and an abutment body on the inner shell which projects in the damping direction.

12. The hydroelastic joint according to claim 8, 9, or 10, wherein the tightening zone of the semi-rigid body forms a lateral partition of the variable-section part of the overpressure channel.

13. The hydroelastic joint according to claim 11, wherein the tightening zone of the semi-rigid body forms a lateral partition of the variable-section part of the overpressure channel.

14. The hydroelastic joint according to claim 12, wherein the lateral partition carries a valve flap that extends towards the opposite sidewall of the overpressure channel.

15. The hydroelastic joint according to claim 12, wherein a sidewall of the overpressure channel opposite the lateral partition of the semi-rigid body carries a valve flap and the lateral partition can contact a free end of the valve flap so as to compress the valve flap.

16. The hydroelastic joint according to claim 12, further comprising a resonance channel extending between the chambers and bypassing the other side of the lateral partition relative to the overpressure channel, wherein the lateral partition has an opening which opens into the resonance channel.

17. The hydroelastic joint according to claim 16, wherein the semi-rigid body can cause a section of the resonance channel defined between the lateral partition and the outer shell to vary in the sense inverse to the variable cross-section of the overpressure channel, so as to increase a resonance frequency of the resonance channel when the inner and outer shells are displaced along the damping direction.

18. The hydroelastic joint according to claim 8, wherein the elastically deformable element has two end portions which hermetically connect the inner and outer shells at the level of opposite ends thereof to enclose the volume of damping liquid, the semi-rigid body being designed so as to ensure an essentially leakproof seal between these end partitions and the edges of the semi-rigid body.

19. The hydroelastic joint according to claim 1, further comprising an additional shell arranged around the outer shell, wherein the force return means comprises a hydraulic circuit defined between the outer shell and the additional shell, and wherein the hydraulic circuit comprises
(a) a first reservoir separated from one of the damping fluid chambers by a first flexible membrane mounted in a first opening of the outer shell opposite an abutment body on the inner shell which projects in the damping direction, and
(b) a second reservoir having a wall formed by a second flexible membrane mounted in a second opening of the outer shell, this second flexible membrane forming an outer sidewall of the variable-section part of the overpressure channel,
wherein the second reservoir is connected to the first reservoir so that an outward deformation of the first membrane under the pressure of the abutment body results, by transmission of hydraulic pressure, in an inward deformation of the second membrane, which constricts the cross-section of the overpressure channel.

20. The hydroelastic joint according to claim 19, further comprising a second elastically deformable element arranged between the additional shell and the outer shell, and the hydraulic circuit is formed within this second elastically deformable element.

21. The hydroelastic joint according to claim 1, further comprising at least one resonance channel that connects the chambers in parallel arrangement with the at least one overpressure channel.
